(19) United States
(12) Patent Application Publication
(10) Pub. No.: US 2026/0279698 A1
(43) Pub. Date: Sep. 17, 2026

(54) ELECTRICAL SWITCH

(71) Applicant: Schneider Electric Industries SAS, Rueil-Malmaison (FR)

(72) Inventors: Xiaojing ZENG, Shanghai (CN); Zhenzhong LIU, Shanghai (CN); Han WANG, Shanghai (CN); Haitao SUN, Shanghai (CN)

(73) Assignee: Schneider Electric Industries SAS, Rueil-Malmaison (FR)

(21) Appl. No.: 19/556,458

(22) Filed: Mar. 4, 2026

(30) Foreign Application Priority Data
Mar. 11, 2025 (CN) 202520412325.4

(51) Int. Cl. H01H 9/34

(52) U.S. Cl. CPC H01H 9/34

(57) ABSTRACT

An electrical switch is disclosed herein that includes a stationary contact assembly including a stationary contact; a moving contact assembly adapted to be switched between a closed position and an open position relative to the stationary contact assembly, the moving contact assembly having a moving contact; an arc extinguishing chamber having a first group of arc extinguishing grids and a second group of arc extinguishing grids with the first group of arc extinguishing grids being closer to the stationary contact than the second group of arc extinguishing grids; and a pair of arc striking pieces. The electrical switch can further include a first arc striking piece of the pair of arc striking pieces that is adjacent to the stationary contact and a second arc striking piece of the pair of arc striking pieces that is adjacent to the moving contact when the moving contact assembly is in the open position.

### CROSS-REFERENCE TO RELATED APPLICATIONS

The application claims priority to Chinese Patent Application No. 202520412325.4 filed on Mar. 11, 2025, entitled “ELECTRICAL SWITCH,” the entirety of which is incorporated herein by reference.

### FIELD OF THE TECHNOLOGY

The present disclosure generally relates to electrical equipment and, more particularly, to electrical switches having an arc extinguishing chamber configured to extinguish electric arcs.

### BACKGROUND

As a protection switch, an electrical switch needs to carry and break a corresponding current. A moving contact assembly of the electrical switch can move and be switched between a closed position and an open position. When the moving contact assembly is in the closed position, the moving contact assembly can be electrically connected to a stationary contact assembly. When the moving contact assembly is in the open position, the moving contact assembly can be opened to a maximum position and disconnected from the stationary contact assembly. At the instant of breaking the moving contact assembly and the stationary contact assembly, an electric arc is generated between the moving contact assembly and the stationary contact assembly.

### SUMMARY

In one aspect of the present disclosure, there is provided an electrical switch includes a stationary contact assembly having a stationary contact and a moving contact assembly adapted to be switched between a closed position and an open position relative to the stationary contact assembly. The moving contact assembly can also include a moving contact. The electrical switch can further include an arc extinguishing chamber having a first group of arc extinguishing grids and a second group of arc extinguishing grids. The first group of arc extinguishing grids can be closer to the stationary contact than the second group of arc extinguishing grids. Adjacent arc extinguishing grids in the first group of arc extinguishing grids can be spaced apart from each other, and adjacent arc extinguishing grids in the second group of arc extinguishing grids can be spaced apart from each other. The electrical switch can further include a pair of arc striking pieces that have a first arc striking piece of the pair of arc striking pieces adjacent to the stationary contact and a second arc striking piece of the pair of arc striking pieces adjacent to the moving contact when the moving contact assembly is in the open position. The first group of arc extinguishing grids and the second group of arc extinguishing grids can be arranged between the pair of arc striking pieces.

In some embodiments, adjacent arc extinguishing grids in the first group of arc extinguishing grids are arranged at an included angle.

In some embodiments, each arc extinguishing grid in the first group of arc extinguishing grids includes a first part and a second part, the first part is closer to the stationary contact than the corresponding second part, and a spacing between the first parts of adjacent arc extinguishing grids in the first group of arc extinguishing grids is smaller than a spacing between the second parts of the adjacent arc extinguishing grids.

In some embodiments, the spacing between the first parts of adjacent arc extinguishing grids in the first group of arc extinguishing grids is equal, and the spacing between the second parts of adjacent arc extinguishing grids in the first group of arc extinguishing grids is equal.

In some embodiments, adjacent arc extinguishing grids in the second group of arc extinguishing grids are arranged at an included angle.

In some embodiments, each arc extinguishing grid in the second group of arc extinguishing grids includes a third part and a fourth part, the third part is closer to the first group of arc extinguishing grids than the corresponding fourth part and is spaced apart from the second part of the first group of arc extinguishing grids, and a spacing between the third parts of adjacent arc extinguishing grids in the second group of arc extinguishing grids is smaller than a spacing between the fourth parts of adjacent arc extinguishing grids.

In some embodiments, the spacing between the third parts of adjacent arc extinguishing grids in the second group of arc extinguishing grids is variable, and the spacing between the fourth parts of adjacent arc extinguishing grids in the second group of arc extinguishing grids is variable.

In some embodiments, a thickness of each arc extinguishing grid in the first group of arc extinguishing grids is greater than a thickness of each arc extinguishing grid in the second group of arc extinguishing grids.

In some embodiments, the arc extinguishing chamber further includes a pair of insulating side plates, and the first group of arc extinguishing grids and the second group of arc extinguishing grids are respectively arranged between the pair of insulating side plates.

In some embodiments, the stationary contact assembly includes a support, the support includes a mounting section, a bent section, and a wiring section spaced apart from the mounting section, and the stationary contact is arranged on the mounting section, wherein the first arc striking piece is arranged on a side of the mounting section facing away from the wiring section, and the second arc striking piece is arranged between the pair of insulating side plates.

In another aspect of the present disclosure, an electrical switch is provided for extinguishing an electric arc that can include a stationary contact assembly having a stationary contact; a moving contact assembly having a moving contact, the contact assembly being configured to move between a closed position in which the moving contact is in contact with the stationary contact and an open position in which the moving contact is not in contact with the stationary contact; and an arc extinguishing chamber adjacent the stationary contact assembly and the moving contact assembly and extending from the stationary contact to a first location of the moving contact when the moving contact is in the open position. The arc extinguishing chamber can include a first group of arc extinguishing grids spaced a first distance from one another and a second group of arc extinguishing grids spaced a second distance from one another that is less than the first distance, wherein the first group of arc extinguishing grids is between the moving contact assembly and the second group of arc extinguishing grids such that the electric arc generated by the stationary contact and the moving contact is cut by the first group of arc extinguishing grids before being cut again by the second group of extinguishing grids.

In some embodiments, the electrical switch can include a first arc striking piece adjacent the stationary contact and a second arc striking piece adjacent the first location of the moving contact, wherein the first group of arc extinguishing grids and the second group of extinguishing grids extend between the first arc striking piece and the second arc striking piece.

In some embodiments, the electrical switch can include that the arc extinguishing chamber extends between the stationary contact and the first location in a curve such that adjacent arc extinguishing grids of the first group of arc extinguishing grids are arranged at an angle respective to one another.

In some embodiments, the electrical switch can include that a length of each arc extinguishing grid in the first group of arc extinguishing grids is greater than a length of each arc extinguishing grid in the second group of arc extinguishing grids.

In some embodiments, the electrical switch can include that a number of arc extinguishing grids in the first group of arc extinguishing grids is less than a number of arc extinguishing grids in the second group of arc extinguishing grids.

In another aspect of the present disclosure, a method of extinguishing an electric arc in an electrical switch is provided that can include generating an electric arc by moving a moving contact of a moving contact assembly from a closed position in which the moving contact is in contact with a stationary contact of a stationary contact assembly to an open position in which the moving contact is not in contact with the stationary contact; allowing the electrical arc to move radially outward within an arc extinguishing chamber adjacent the stationary contact assembly and the moving contact assembly with the arc extinguishing chamber extending from the stationary contact to a first location of the moving contact when in the open position; cutting the electric arc into a first set of sub-arcs by a first group of arc extinguishing grids spaced a first distance from one another as the electrical arc continues to move radially outward within the arc extinguishing chamber; and cutting the first set of sub-arcs into a second set of sub-arcs by a second group of arc extinguishing grids spaced a second distance from one another as the first set of sub-arcs continue to move radially outward within the arc extinguishing chamber, the first group of arc extinguishing grids being closer to the stationary contact than the second group of arc extinguishing grids.

In some embodiments, the method can include that the first distance between adjacent arc extinguishing grids of the first group of arc extinguishing grids is greater than the second distance between adjacent arc extinguishing grids of the second group of arc extinguishing grids such that a height of the first set of sub-arcs is greater than a height of the second set of sub-arcs.

In some embodiments, the method can include that a length of each arc extinguishing grid of the first group of arc extinguishing grids is greater than a length of each arc extinguishing grid of the second group of arc extinguishing grids.

In some embodiment, the method can include that the electrical switch includes a first arc striking piece adjacent the stationary contact and a second arc striking piece adjacent the moving contact when at the first location, and wherein the first group of arc extinguishing grids and the second group of extinguishing grids extend between the first arc striking piece and the second arc striking piece.

In some embodiments, the method can include cooling the electric arc, the first set of sub-arcs, and the second set of sub-arcs as each moves radially outward within the arc extinguishing chamber.

It should be understood that the content described in this section is not intended to limit the key features or important features of embodiments of the present disclosure, nor is it intended to limit the scope of the present disclosure. Other features of the present disclosure will become readily understood from the following description.

### BRIEF DESCRIPTION OF THE DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements. A more detailed description of the disclosure may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 illustrates a schematic diagram of a partial structure of an example electrical switch according to some embodiments of the present disclosure.

FIG. 2 illustrates a schematic diagram of a partial structure of the example electrical switch shown in FIG. 1 from another viewing angle.

FIG. 3 illustrates a schematic structural diagram of an example stationary contact assembly, an example arc extinguishing chamber, an example magnetic conductive member, an example second arc striking piece, and an example gas-generating member according to some embodiments of the present disclosure.

FIG. 4 illustrates a cross-sectional view of an example electrical switch according to some embodiments of the present disclosure.

FIG. 5 illustrates a schematic structural diagram of an example first group of arc extinguishing grids, an example second group of arc extinguishing grids, and an example pair of arc striking pieces according to some embodiments of the present disclosure.

### DETAILED DESCRIPTION

### Description of Reference Numerals

100 is an electrical switch, 101 is an accommodating chamber, and 102 is an installation space;

1 is a stationary contact assembly, 11 is a stationary contact, 12 is a support, 121 is a mounting section, 122 is a bent section, and 123 is a wiring section;

2 is a moving contact assembly, and 21 is a moving contact;

3 is an arc extinguishing chamber, 31 is a first group of arc extinguishing grids, 311 is a first part, 312 is a second part, 32 is a second group of arc extinguishing grids, 321 is a third part, 322 is a fourth part, and 33 is an insulating side plate;

4 is a pair of arc striking pieces, 41 is a first arc striking piece, and 42 is a second arc striking piece;

5 is a gas-generating member, and 51 is an isolating portion;

6 is a magnetic conductive member, 61 is a connecting portion, and 62 is an extension portion.

Preferred embodiments of the present disclosure will be described in more detail below with reference to the accompanying drawings. Although preferred embodiments of the present disclosure are illustrated in the accompanying drawings, it should be understood that the present disclosure may be implemented in various forms and should not be limited by embodiments set forth herein. Rather, these embodiments are provided to make the present disclosure more thorough and complete, and to fully convey the scope of the present disclosure to those skilled in the art.

As used herein, the term "including" and variations thereof indicate open-ended inclusion, for example, "including but not limited to." Unless specifically stated, the term "or" means "and/or." The terms "some example embodiments" and "some embodiments" indicate "at least some example embodiments." The term "some other embodiments" indicates "at least some other embodiments." The terms "first," "second," and the like may refer to different or identical objects.

As described above, at the instant of breaking the moving contact assembly and the stationary contact assembly, an electric arc is generated between the moving contact assembly and the stationary contact assembly. A conventional electrical switch employs an arc extinguishing chamber assembly to guide arc movement through metal grids and to split and cool the arc, thereby rapidly extinguishing the arc. Design parameters such as the shape, arrangement, and material selection of the metal grids directly affect arc energy dissipation efficiency and breaking reliability. In addition to the design parameters regarding the shape and arrangement of the metal grids, a larger number of metal grids leads to a larger heat capacity, which is beneficial for extinguishing the arc; however, this generally increases the size of the arc extinguishing apparatus. In addition, for an electrical switch used for direct current, since direct current has no zero-crossing point, the difficulty of arc extinguishing is increased, which requires an arc extinguishing apparatus with better arc extinguishing performance.

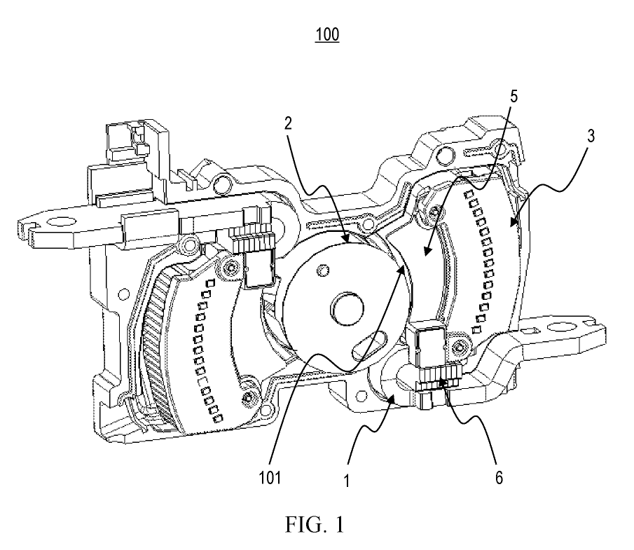

Based on this, embodiments of the present disclosure provide an electrical switch, which aims to improve arc extinguishing performance without increasing the space occupied by the arc extinguishing apparatus. Hereinafter, the principles of the present disclosure will be described with reference to FIGS. 1 to 5.

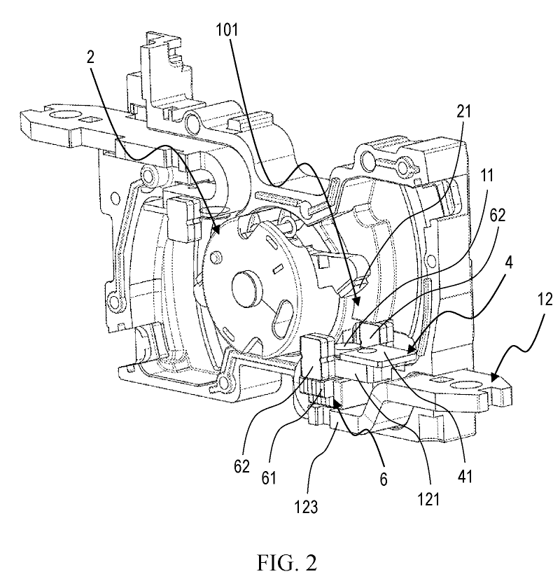

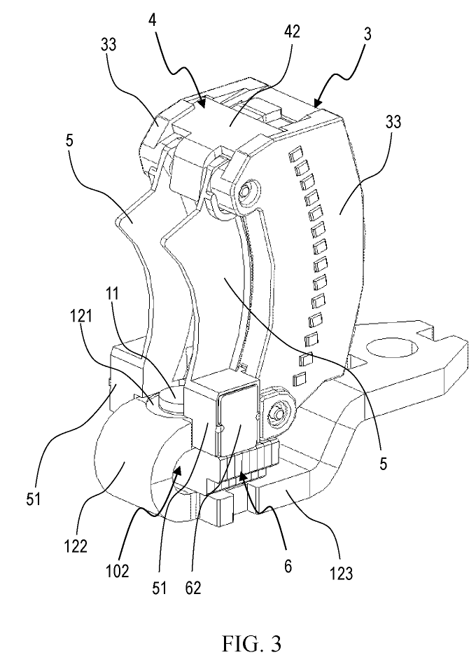

FIG. 1 illustrates a schematic diagram of a partial structure of an example electrical switch 100 according to some embodiments of the present disclosure. FIG. 2 illustrates a schematic diagram of a partial structure of the example electrical switch 100 shown in FIG. 1 from another viewing angle, where an arc extinguishing chamber 3, a gas-generating member 5, and a second arc striking piece 42 are not shown. FIG. 3 illustrates a schematic structural diagram of an example stationary contact assembly 1, an example arc extinguishing chamber 3, an example magnetic conductive member 6, an example second arc striking piece 42, and an example gas-generating member 5 according to some embodiments of the present disclosure. As shown in FIGS. 1 to 3, the electrical switch 100 described herein generally includes a stationary contact assembly 1, a moving contact assembly 2, an arc extinguishing chamber 3, a pair of arc striking pieces 4, a pair of gas-generating members 5, and a magnetic conductive member 6. The arc extinguishing chamber 3, the stationary contact assembly 1, the moving contact assembly 2, and the pair of gas-generating members 5 together surround an accommodating chamber 101.

With continued reference to FIG. 2, in some embodiments, the moving contact assembly 2 is movable relative to the stationary contact assembly 1 to be switched between a closed position and an open position. The moving contact assembly 2 includes a moving contact 21, and correspondingly, the stationary contact assembly 1 includes a stationary contact 11. It can be understood that, when the moving contact assembly 2 is in the closed position, the moving contact 21 can be electrically connected to the stationary contact 11. When the moving contact assembly 2 is in the open position, the moving contact 21 can be disconnected from the stationary contact 11 and located at a maximum opening distance from the stationary contact 11.

Referring to FIGS. 1 to 3, in some embodiments, the stationary contact assembly 1 may further include a support 12. The stationary contact 11 may be arranged on the support 12, and the support 12 may surround an installation space 102. A part of the magnetic conductive member 6 may be located within the installation space 102. Further, the magnetic conductive member 6 may include a connecting portion 61 and a pair of extension portions 62. The connecting portion 61 may be arranged in the installation space 102, and the pair of extension portions 62 may be connected to the connecting portion 61 and spaced apart from each other.

With continued reference to FIGS. 2 and 3, the support 12 may include a mounting section 121, a bent section 122, and a wiring section 123 spaced apart from the mounting section 121. The mounting section 121, the bent section 122, and the wiring section 123 together surround the installation space 102. The stationary contact 11 may be arranged on a side of the mounting section 121 facing away from the wiring section 123. The pair of extension portions 62 may be arranged on a side of the connecting portion 61 facing away from the wiring section 123, and a part of the mounting section 121 and the stationary contact 11 may be located between the pair of extension portions 62. In this way, an arc located within the accommodating chamber and at the stationary contact 11 can be guided by the pair of extension portions 62 and move towards the arc extinguishing chamber 3.

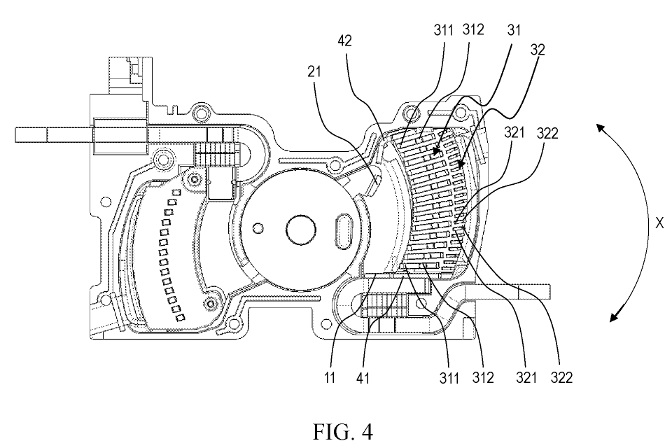

FIG. 4 illustrates a cross-sectional view of the electrical switch 100 according to some embodiments of the present disclosure. As shown in FIGS. 3 and 4, the arc extinguishing chamber 3 includes a first group of arc extinguishing grids 31 and a second group of arc extinguishing grids 32. The first group of arc extinguishing grids 31 is closer to the stationary contact 11 than the second group of arc extinguishing grids 32. Adjacent arc extinguishing grids in the first group of arc extinguishing grids 31 are spaced apart from each other, and adjacent arc extinguishing grids in the second group of arc extinguishing grids 32 are spaced apart from each other.

Referring to FIGS. 3 and 4, further, the first arc striking piece 41 is adjacent to the stationary contact 11, and when the moving contact assembly 2 is in the open position, the second arc striking piece 42 is adjacent to the moving contact 21. The first group of arc extinguishing grids 31 and the second group of arc extinguishing grids 32 may be arranged between the pair of arc striking pieces 4. That is, the first group of arc extinguishing grids 31 and the second group of arc extinguishing grids 32 extend from the stationary contact 11 to the maximum opening distance of the moving contact 21 from the stationary contact 11.

Referring to FIGS. 3 and 4, further, one arc extinguishing grid located on an outer side in the first group of arc extinguishing grids 31 and one arc extinguishing grid located on an outer side in the second group of arc extinguishing grids 32 are adjacent to the first arc striking piece 41, and another arc extinguishing grid located on another outer side in the first group of arc extinguishing grids 31 and another arc extinguishing grid located on another outer side in the second group of arc extinguishing grids 32 are adjacent to the second arc striking piece 42. That is, the first group of arc extinguishing grids 31 and the second group of arc extinguishing grids 32 extend from the first arc striking piece 41 to the second arc striking piece 42. In this way, when the arc is guided to the arc extinguishing chamber 3, the stationary contact assembly 1, the first arc striking piece 41, the first group of arc extinguishing grids 31, the second group of arc extinguishing grids 32, the second arc striking piece 42, and the moving contact assembly 2 can form a pathway, thereby achieving arc extinguishing.

According to embodiments of the present disclosure, when the moving contact 21 and the stationary contact 11 break to generate an arc, the first group of arc extinguishing grids 31 can cut a long arc into short arcs, and then the second group of arc extinguishing grids 32 can cause the short arcs to be further cut. In addition, since the second group of arc extinguishing grids 32 are distributed on an outer side, a movement path of the arc can be increased. In this way, the arc can be cut and cooled, so as to increase an arc voltage and improve arc extinguishing capability. Therefore, the electrical switch 100 according to embodiments of the present disclosure improves the arc extinguishing performance without increasing the space of the arc extinguishing chamber, and ensures reliable breaking of the electrical switch 100. In addition, the electrical switch 100 according to embodiments of the present disclosure has a small size and good arc extinguishing performance, making the product better applied to high-voltage direct current applications.

Referring to FIGS. 3 and 4, in some embodiments, along an arrangement direction X of the first group of arc extinguishing grids 31, the first group of arc extinguishing grids 31 and the second group of arc extinguishing grids 32 may be arranged between the pair of arc striking pieces 4. It should be noted that the arrangement direction X of the first group of arc extinguishing grids 31 may be the same as or different from an arrangement direction of the second group of arc extinguishing grids 32, which is not limited by embodiments of the present disclosure.

Referring to FIGS. 3 and 4, in some embodiments, the arc extinguishing chamber 3 may further include a pair of insulating side plates 33. The first group of arc extinguishing grids 31 and the second group of arc extinguishing grids 32 are respectively arranged between the pair of insulating side plates 33. The arc extinguishing grids according to embodiments of the present disclosure may be assembled between the pair of insulating side plates 33 in any manner, for example, by snapping and the like, which is not limited by embodiments of the present disclosure.

In some embodiments, referring back to FIG. 2, the first arc striking piece 41 may be arranged on a side of the mounting section 121 facing away from the wiring section 123. Referring back to FIG. 3, the second arc striking piece 42 may be arranged between the pair of insulating side plates 33. In this way, when the arc is guided to the arc extinguishing chamber 3, the stationary contact 11, the first arc striking piece 41, the first group of arc extinguishing grids 31, the second group of arc extinguishing grids 32, the second arc striking piece 42, and the moving contact 21 can form a pathway, thereby achieving arc extinguishing.

Referring back to FIGS. 1 and 3, in some embodiments, the pair of gas-generating members 5 may each be arranged on a respective insulating side plate 33. The connection manner between the gas-generating member 5 and the insulating side plate 33 is not limited herein. Further, one side of the pair of gas-generating members 5 is connected to the corresponding insulating side plate 33, and another side of the pair of gas-generating members 5 is adjacent to the moving contact 21 and the stationary contact 11. It can be understood that, since the temperature of the arc is relatively high, the pair of gas-generating members 5 can release gas at high temperatures, such that a pressure adjacent to the moving contact assembly 2 in the accommodating chamber 101 is greater than a pressure adjacent to the arc extinguishing chamber 3 in the accommodating chamber 101, thereby assisting the arc to move toward the arc extinguishing chamber 3 via a pressure difference.

The gas-generating member 5 according to embodiments of the present disclosure may include various types of materials currently known or available in the future, which is not limited by embodiments of the present disclosure, as long as it can release gas in a high-temperature environment. For example, in some embodiments, the gas-generating member 5 may be a nylon component. In addition, referring to FIG. 3, the gas-generating member 5 is further provided with an isolating portion 51 wrapping the extension portion 62, so as to prevent the extension portion 62 from being electrically connected by the stationary contact 11.

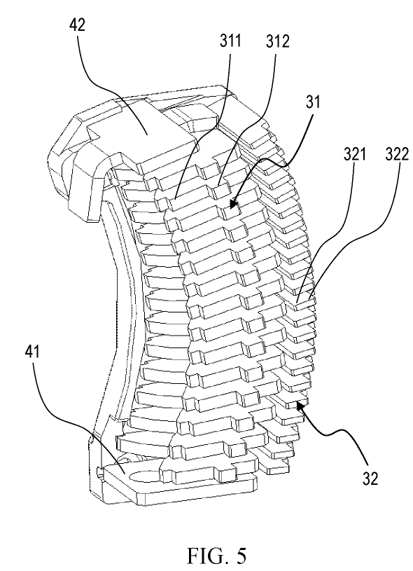

FIG. 5 illustrates a schematic structural diagram of the first group of arc extinguishing grids 31, the second group of arc extinguishing grids 32, and the pair of arc striking pieces 4 according to some embodiments of the present disclosure. As shown in FIGS. 4 and 5, in some implementations, a thickness of each arc extinguishing grid in the first group of arc extinguishing grids 31 is greater than a thickness of each arc extinguishing grid in the second group of arc extinguishing grids 32. It can be understood that the first group of arc extinguishing grids 31 can cut a long arc into short arcs; since the energy of the long arc is relatively high, it is necessary to thicken each arc extinguishing grid in the first group of arc extinguishing grids 31 to bear the energy of the long arc. The second group of arc extinguishing grids 32 can cause the short arcs to be further cut into shorter arcs, therefore it is necessary to thin each arc extinguishing grid in the second group of arc extinguishing grids 32 for better cutting the short arcs.

In this way, since the second group of arc extinguishing grids 32 are distributed on the outer side, and the thickness of each arc extinguishing grid in the first group of arc extinguishing grids 31 is greater than the thickness of each arc extinguishing grid in the second group of arc extinguishing grids 32, when the spacing between adjacent arc extinguishing grids in the first group of arc extinguishing grids 31 is equal to or slightly different from the spacing between adjacent arc extinguishing grids in the second group of arc extinguishing grids 32, the number of arc extinguishing grids in the second group of arc extinguishing grids 32 is greater than the number of arc extinguishing grids in the first group of arc extinguishing grids 31, thereby facilitating the short arcs to be further cut.

Referring to FIGS. 4 and 5, in some embodiments, adjacent arc extinguishing grids in the first group of arc extinguishing grids 31 may be arranged at an included angle. Each arc extinguishing grid in the first group of arc extinguishing grids 31 may include a first part 311 and a second part 312. The first part 311 is closer to the stationary contact 11 than the corresponding second part 312, and a spacing between the first parts 311 of adjacent arc extinguishing grids in the first group of arc extinguishing grids 31 is smaller than a spacing between the second parts 312 of adjacent arc extinguishing grids. That is, the arc extinguishing grids in the first group of arc extinguishing grids 31 are radial. In this way, the pressure at the moving contact assembly 2 is greater than the pressure at the arc extinguishing chamber 3, thereby assisting the arc to move toward the arc extinguishing chamber 3 via the pressure difference. In addition, the first group of arc extinguishing grids 31 can cut a long arc into short arcs.

Referring to FIGS. 4 and 5, in some embodiments, the spacing between the first parts 311 of adjacent arc extinguishing grids in the first group of arc extinguishing grids 31 may be equal, and the spacing between the second parts 312 of adjacent arc extinguishing grids in the first group of arc extinguishing grids 31 may be equal. That is, the arc extinguishing grids in the first group of arc extinguishing grids 31 can extend to the same point. In this way, the pressure at the moving contact assembly 2 is greater than the pressure at the arc extinguishing chamber 3, thereby assisting the arc to move toward the arc extinguishing chamber 3 via the pressure difference. In addition, the first group of arc extinguishing grids 31 can cut a long arc into short arcs.

It should be noted that, in some other embodiments, the spacing between the first parts 311 of adjacent arc extinguishing grids in the first group of arc extinguishing grids 31 may also be variable, and the spacing between the second parts 312 of adjacent arc extinguishing grids in the first group of arc extinguishing grids 31 may also be variable.

With continued reference to FIGS. 4 and 5, in some embodiments, adjacent arc extinguishing grids in the second group of arc extinguishing grids 32 may be arranged at an included angle. Each arc extinguishing grid in the second group of arc extinguishing grids 32 may include a third part 321 and a fourth part 322. The third part 321 is closer to the first group of arc extinguishing grids 31 than the corresponding fourth part 322, and is spaced apart from the second part 312 of the first group of arc extinguishing grids 31. A spacing between the third parts 321 of adjacent arc extinguishing grids in the second group of arc extinguishing grids 32 is smaller than a spacing between the fourth parts 322 of adjacent arc extinguishing grids. That is, the arc extinguishing grids in the second group of arc extinguishing grids 32 are similarly radial.

Referring to FIGS. 4 and 5, in some embodiments, the spacing between the third parts 321 of adjacent arc extinguishing grids in the second group of arc extinguishing grids 32 may be variable, for example, the spacing is similar. The spacing between the fourth parts 322 of adjacent arc extinguishing grids in the second group of arc extinguishing grids 32 may be variable, for example, the spacing is similar. That is, the arc extinguishing grids in the second group of arc extinguishing grids 32 can similarly extend to the same point.

It should be noted that, in some other embodiments, the spacing between the third parts 321 of adjacent arc extinguishing grids in the second group of arc extinguishing grids 32 may also be equal, and the spacing between the fourth parts 322 of adjacent arc extinguishing grids in the second group of arc extinguishing grids 32 may also be equal.

In some embodiments, the spacing between adjacent arc extinguishing grids in the first group of arc extinguishing grids 31 and the spacing between adjacent arc extinguishing grids in the second group of arc extinguishing grids 32 may be equal. In some other embodiments, the spacing between adjacent arc extinguishing grids in the first group of arc extinguishing grids 31 and the spacing between adjacent arc extinguishing grids in the second group of arc extinguishing grids 32 may also be variable, but with a small difference. It should be noted that the spacing between adjacent arc extinguishing grids in the first group of arc extinguishing grids 31 and the spacing between adjacent arc extinguishing grids in the second group of arc extinguishing grids 32 should not be set to a value that is too large or too small, so as to avoid the problem of overheating or even melting of the grids caused by being too close, and to avoid the problem of poor arc extinguishing effect caused by being too far.

According to embodiments of the present disclosure, when the moving contact and the stationary contact break to generate an arc, the first group of arc extinguishing grids can cut a long arc into short arcs, and then the second group of arc extinguishing grids can cause the short arcs to be further cut. In addition, since the second group of arc extinguishing grids are distributed on an outer side, a movement path of the arc can be increased. In this way, the arc can be cut and cooled, so as to increase an arc voltage and improve arc extinguishing capability. Therefore, the electrical switch according to embodiments of the present disclosure improves the arc extinguishing performance without increasing the space of the arc extinguishing chamber, and ensures reliable breaking of the electrical switch.

The arc extinguishing design according to embodiments of the present disclosure may be applied to various electrical switches to at least partially solve the above problems. It should be understood that the arc extinguishing design according to embodiments of the present disclosure may also be applied to other electrical components, which is not limited by embodiments of the present disclosure.

Various embodiments of the present disclosure have been described above. The above descriptions are illustrative, not exhaustive, and are not limited to the disclosed embodiments. Many modifications and variations will be apparent to those of ordinary skill in the art without departing from the scope and spirit of the illustrated embodiments. The selection of terms used herein is intended to best explain the principles of the embodiments, practical applications, or technical improvements in the market, or to enable others of ordinary skill in the art to understand embodiments disclosed herein.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An electrical switch, comprising:
a stationary contact assembly comprising a stationary contact;
a moving contact assembly adapted to be switched between a closed position and an open position relative to the stationary contact assembly, and comprising a moving contact;
an arc extinguishing chamber comprising a first group of arc extinguishing grids and a second group of arc extinguishing grids, the first group of arc extinguishing grids being closer to the stationary contact than the second group of arc extinguishing grids, adjacent arc extinguishing grids in the first group of arc extinguishing grids being spaced apart from each other, and adjacent arc extinguishing grids in the second group of arc extinguishing grids being spaced apart from each other; and
a pair of arc striking pieces, a first arc striking piece of the pair of arc striking pieces being adjacent to the stationary contact, and a second arc striking piece of the pair of arc striking pieces being adjacent to the moving contact when the moving contact assembly is in the open position, wherein the first group of arc extinguishing grids and the second group of arc extinguishing grids are arranged between the pair of arc striking pieces.

2. The electrical switch according to claim 1, wherein adjacent arc extinguishing grids in the first group of arc extinguishing grids are arranged at an included angle.

3. The electrical switch according to claim 2, wherein each arc extinguishing grid in the first group of arc extinguishing grids comprises a first part and a second part, the first part is closer to the stationary contact than the corresponding second part, and a spacing between the first parts of adjacent arc extinguishing grids in the first group of arc extinguishing grids is smaller than a spacing between the second parts of the adjacent arc extinguishing grids.

4. The electrical switch according to claim 3, wherein the spacing between the first parts of adjacent arc extinguishing grids in the first group of arc extinguishing grids is equal, and the spacing between the second parts of adjacent arc extinguishing grids in the first group of arc extinguishing grids is equal.

5. The electrical switch according to claim 3, wherein adjacent arc extinguishing grids in the second group of arc extinguishing grids are arranged at an included angle.

6. The electrical switch according to claim 5, wherein each arc extinguishing grid in the second group of arc extinguishing grids comprises a third part and a fourth part, the third part is closer to the first group of arc extinguishing grids than the corresponding fourth part and is spaced apart from the second part of the first group of arc extinguishing grids, and a spacing between the third parts of adjacent arc extinguishing grids in the second group of arc extinguishing grids is smaller than a spacing between the fourth parts of the adjacent arc extinguishing grids.

7. The electrical switch according to claim 6, wherein the spacing between the third parts of adjacent arc extinguishing grids in the second group of arc extinguishing grids is variable, and the spacing between the fourth parts of adjacent arc extinguishing grids in the second group of arc extinguishing grids is variable.

8. The electrical switch according to claim 1, wherein a thickness of each arc extinguishing grid in the first group of arc extinguishing grids is greater than a thickness of each arc extinguishing grid in the second group of arc extinguishing grids.

9. The electrical switch according to claim 1, wherein the arc extinguishing chamber further comprises a pair of insulating side plates, and the first group of arc extinguishing grids and the second group of arc extinguishing grids are respectively arranged between the pair of insulating side plates.

10. The electrical switch according to claim 9, wherein the stationary contact assembly comprises a support, the support comprises a mounting section, a bent section and a wiring section spaced apart from the mounting section, and the stationary contact is arranged on the mounting section, wherein the first arc striking piece is arranged on a side of the mounting section facing away from the wiring section, and the second arc striking piece is arranged between the pair of insulating side plates.

11. An electrical switch for extinguishing an electric arc, the electrical switch comprising:
a stationary contact assembly having a stationary contact;
a moving contact assembly having a moving contact, the contact assembly being configured to move between a closed position in which the moving contact is in contact with the stationary contact and an open position in which the moving contact is not in contact with the stationary contact; and
an arc extinguishing chamber adjacent the stationary contact assembly and the moving contact assembly and extending from the stationary contact to a first location of the moving contact when the moving contact is in the open position, the arc extinguishing chamber comprising:
a first group of arc extinguishing grids spaced a first distance from one another; and
a second group of arc extinguishing grids spaced a second distance from one another that is less than the first distance,
wherein the first group of arc extinguishing grids is between the moving contact assembly and the second group of arc extinguishing grids such that the electric arc generated by the stationary contact and the moving contact is cut by the first group of arc extinguishing grids before being cut again by the second group of extinguishing grids.

12. The electrical switch according to claim 11, further comprising:
a first arc striking piece adjacent the stationary contact; and
a second arc striking piece adjacent the first location of the moving contact,
wherein the first group of arc extinguishing grids and the second group of extinguishing grids extend between the first arc striking piece and the second arc striking piece.

13. The electrical switch according to claim 11, wherein the arc extinguishing chamber extends between the stationary contact and the first location in a curve such that adjacent arc extinguishing grids of the first group of arc extinguishing grids are arranged at an angle respective to one another.

14. The electrical switch according to claim 11, wherein a length of each arc extinguishing grid in the first group of arc extinguishing grids is greater than a length of each arc extinguishing grid in the second group of arc extinguishing grids.

15. The electrical switch according to claim 11, wherein a number of arc extinguishing grids in the first group of arc extinguishing grids is less than a number of arc extinguishing grids in the second group of arc extinguishing grids.

16. A method of extinguishing an electric arc in an electrical switch, the method comprising:
generating an electric arc by moving a moving contact of a moving contact assembly from a closed position in which the moving contact is in contact with a stationary contact of a stationary contact assembly to an open position in which the moving contact is not in contact with the stationary contact;
allowing the electrical arc to move radially outward within an arc extinguishing chamber adjacent the stationary contact assembly and the moving contact assembly with the arc extinguishing chamber extending from the stationary contact to a first location of the moving contact when in the open position;
cutting the electric arc into a first set of sub-arcs by a first group of arc extinguishing grids spaced a first distance from one another as the electrical arc continues to move radially outward within the arc extinguishing chamber; and
cutting the first set of sub-arcs into a second set of sub-arcs by a second group of arc extinguishing grids spaced a second distance from one another as the first set of sub-arcs continue to move radially outward within the arc extinguishing chamber, the first group of arc extinguishing grids being closer to the stationary contact than the second group of arc extinguishing grids.

17. The method according to claim 16, wherein the first distance between adjacent arc extinguishing grids of the first group of arc extinguishing grids is greater than the second distance between adjacent arc extinguishing grids of the second group of arc extinguishing grids such that a height of the first set of sub-arcs is greater than a height of the second set of sub-arcs.

18. The method of according to claim 16, wherein a length of each arc extinguishing grid of the first group of arc extinguishing grids is greater than a length of each arc extinguishing grid of the second group of arc extinguishing grids.

19. The method of claim 16, wherein the electrical switch includes a first arc striking piece adjacent the stationary contact and a second arc striking piece adjacent the moving contact when at the first location, and wherein the first group of arc extinguishing grids and the second group of extinguishing grids extend between the first arc striking piece and the second arc striking piece.

20. The method of claim 16, further comprising:
cooling the electric arc, the first set of sub-arcs, and the second set of sub-arcs as each moves radially outward within the arc extinguishing chamber.
